(19) United States
(12) Patent Application Publication
(10) Pub. No.: US 2006/0116495 A1
(43) Pub. Date: Jun. 1, 2006

(54) Silicone polymerisates

(76) Inventors: Kurt Stark, Weilersbach (DE); Christian Herzig, Waging am See (DE); Christian Hogl, Reut (DE)

Correspondence Address: BROOKS KUSHMAN P.C., 1000 TOWN CENTER, TWENTY-SECOND FLOOR, SOUTHFIELD, MI, 48075, US

(21) Appl. No.: 10/542,800

(22) PCT Filed: Dec. 18, 2003
(86) PCT No.: PCT/EP03/14490

§ 371 Date: Jul. 19, 2005

(30) Foreign Application Priority Data
Jan. 20, 2003 (DE) 103 01 976.6

(51) Int. Cl. C08F 230/08; C08F 20/06

(52) U.S. Cl. 526/279; 526/317.1

(57) ABSTRACT

Silicone-containing polymers having numerous uses are prepared by polymerizing one or more ethylenically unsaturated monomers in the presence of a branched organopolysiloxane having at least one lipophilic branched siloxane portion and at least one optionally branched hydrophilic portion.

The invention relates to silicone-containing polymers, a process for producing them and their use.

Organosilicon compounds such as organosiloxane polymers are used for hydrophobicizing polymers of ethylenically unsaturated monomers. Such hydrophobically modified polymers are used in many fields in the form of their polymer powders, in particular water-redispersible polymer powders, or as aqueous polymer dispersions. They are employed as binders in coating compositions or adhesives, in particular in the building sector and textile sector, and as binders in cosmetics and hair care compositions.

It is known from WO-A 95/20626 that water-redispersible polymer powders can be modified by addition of noncopolymerizable organosilicon compounds. EP-A 0352339 describes protective paints for concrete constructions, which comprise copolymers of divinyl-polydimethylsiloxane with acrylate or methacrylate esters and vinyl- or acryl-functional alkoxysilanes as a solution in organic solvents. EP-B 771826 describes aqueous binders for coatings and adhesives based on emulsion polymers of vinyl esters, acrylic or methacrylic esters or vinylaromatics which comprise polysiloxanes having unsaturated radicals, for example vinyl, acryloxy or methacryloxy groups, as cross-linkers. EP-A 943634 describes aqueous latices prepared by copolymerization of ethylenically unsaturated monomers in the presence of a silicone resin containing silanol groups for use as coating compositions. EP-A 1095953 describes silicone-grafted vinyl copolymers in which a carbosiloxane dendrimer is grafted onto the vinyl polymer.

It is known from DE-A 19951877 and WO-A 99/04750 that silicone-containing polymers are obtainable by polymerization of ethylenically unsaturated monomers in the presence of a linear polydialkylsiloxane having polyalkylene oxide side chains. Disadvantages are the tendency to form coagulum and the broad particle size distribution of the products. U.S. Pat. No. 5,216,070 describes a process for the inverse emulsion polymerization of carboxyl-functional monomers, in which linear polydialkylsiloxanes having polyalkylene oxide side chains are used as emulsifier. DE-A 4240108 describes a polymerization process for preparing polysiloxane-containing binders for use in dirt-repellent coatings, in which the monomers are polymerized in the presence of an OH—, COOH— or epoxy-functional polydialkylsiloxane which may additionally contain polyether groups. DE-A 10041163 discloses a process for producing hair cosmetic formulations, in which vinyl esters are polymerized in the presence of a polyether-containing compound, for example polyether-containing silicone compounds.

A disadvantage of the silicone-modified emulsion polymers described in the prior art is a strong tendency to hydrolyze and to undergo uncontrolled crosslinking, which may well be desirable in some applications and be reinforced subsequently by addition of silane and catalyst, but in the case of paint dispersions or in coating compositions leads to undesirable gel particles (“specks”) and insoluble constituents. Furthermore, the silicone-containing emulsion polymers known hitherto are often not resistant to alkali, since silicones are known to be unstable in an alkaline medium. For this reason, the hydrophobicity and the associated positive properties decrease very greatly in the systems described hitherto after a relatively long period of time. Finally, the introduction of a large amount of silanes or silicones into the emulsion polymers leads to an unsatisfactory particle size distribution, i.e. the particles become too large and the polymer becomes inhomogeneous, which can result in serum formation or phase separation.

It was an object of the invention to develop polymers which are hydrolysis-resistant and hydrophobic and therefore weathering-stable, water-repellent and nonsoiling and additionally have a good water vapor permeability and a high wet abrasion resistance. A further object is to provide a process by means of which hydrophobically modified polymers having a narrow particle size distribution and no coagulation can be obtained.

The invention provides silicone-containing polymers obtainable by means of free-radical polymerization of ethylenically unsaturated monomers in the presence of a polysiloxane, characterized in that

a) from 60 to 99.99% by weight of one or more monomers selected from the group consisting of vinyl esters of unbranched or branched alkylcarboxylic acids having from 1 to 15 carbon atoms, methacrylic esters and acrylic esters of alcohols having 1 to 15 carbon atoms, vinylaromatics, olefins, dienes and vinyl halides are polymerized in the presence of

b) from 0.01 to 40% by weight of at least one branched polysiloxane whose lipophilic siloxane part comprises branched structures and whose hydrophilic organopolymer part can be linear or branched, where the % by weight are based on the total weight of a) and b).

Suitable vinyl esters are vinyl esters of unbranched or branched carboxylic acids having from 1 to 15 carbon atoms. Preferred vinyl esters are vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids having from 5 to 13 carbon atoms, for example VeoVa9^{R} or VeoVa10^{R} (trade names of Shell). Particular preference is given to vinyl acetate and the greatest preference is given to a combination of vinyl acetate with α-branched monocarboxylic acids having from 5 to 11 carbon atoms, e.g. VeoVa10.

Suitable monomers from the group consisting of esters of acrylic acid or methacrylic acid are esters of unbranched or branched alcohols having from 1 to 15 carbon atoms. Preferred methacrylic esters or acrylic esters are methyl acrylate, methyl methacrylate, ethyl acrylate, ethyl methacrylate, propyl acrylate, propyl methacrylate, n-butyl, isobutyl and t-butyl acrylate, n-butyl, isobutyl and t-butyl methacrylate, 2-ethylhexyl acrylate, norbornyl acrylate. Particular preference is given to methyl acrylate, methyl methacrylate, n-butyl, isobutyl and t-butyl acrylate, 2-ethylhexyl acrylate and norbornyl acrylate.

Suitable dienes are 1,3-butadiene and isoprene. Examples of copolymerizable olefins are ethene and propene. As vinylaromatics, it is possible to copolymerize styrene and vinyltoluene. From the group consisting of vinyl halides, it is usual to use vinyl chloride, vinylidene chloride or vinyl fluoride, preferably vinyl chloride.

If desired, from 0.05 to 30% by weight, based on the total weight of the monomers a), of one or more auxiliary monomers can additionally be copolymerized. Examples of auxiliary monomers are ethylenically unsaturated monocarboxylic and dicarboxylic acids or salts thereof, preferably crotonic acid, acrylic acid, methacrylic acid, fumaric acid and maleic acid; ethylenically unsaturated carboxamides and carboxylic nitriles, preferably acrylamide and acrylonitrile; monoesters and diesters of fumaric acid and maleic acid, e.g. the diethyl and diisopropyl esters, and also maleic anhydride, ethylenically unsaturated sulfonic acids or salts thereof, preferably vinylsulfonic acid, 2-acrylamido-2-methylpropanesulfonic acid. Further suitable auxiliary monomers are cationic monomers such as diallyldimethylammonium chloride (DADMAC), 3-trimethylammoniopropyl(meth)acrylamide chloride (MAPTAC) and 2-trimethylammonioethyl (meth)acrylate chloride. Also suitable are vinyl ethers, vinyl ketones, further vinylaromatic compounds which may also have heteroatoms. Suitable auxiliary monomers also include polymerizable silanes and mercaptosilanes. Preference is given to γ-acryl- or γ-methacryloxypropyltri(alkoxy)silanes, α-methacryloxymethyltri(alkoxy)silanes, γ-methacryloxy-propylmethyldi(alkoxy)silanes, vinylalkyldi(alkoxy)silanes and vinyltri(alkoxy)silanes, with alkoxy groups used being, for example, methoxy, ethoxy, methoxyethylene, ethoxyethylene, methoxypropylene glycol ether or ethoxypropylene glycol ether radicals. Examples of such silanes are vinyltrimethoxysilane, vinyltriethoxysilane, vinyltripropoxysilane, vinyltriisopropoxysilane, vinyltris(1-methoxy)isopropoxysilane, vinyltributoxysilane, vinyltriacetoxysilane, 3-methacryloxy-propyltrimethoxysilane, 3-methacryloxypropylmethyldimethoxysilane, methacryloxymethyltrimethoxysilane, 3-methacryloxypropyltris(2-methoxyethoxy)silane, vinyltrichlorosilane, vinylmethyldichlorosilane, vinyltris-(2-methoxyethoxy)silane, trisacetoxyvinylsilane, 3-(triethoxysilyl)propyl(succinic anhydride)silane. Preference is also given to 3-mercaptopropyltriethoxysilane, 3-mercaptopropyltrimethoxysilane and 3-mercaptopropylmethyldimethoxysilane.

Further examples are functionalized (meth)acrylates, in particular epoxy-functionalized (meth)acrylates such as glycidyl acrylate, glycidyl methacrylate, allyl glycidyl ether, vinyl glycidyl ether, or hydroxyalkyl-functional (meth)acrylates such as hydroxyethyl (meth)acrylate, or substituted or unsubstituted aminoalkyl (meth)acrylates, or cyclic monomers such as N-vinylpyrrolidone.

Also suitable are polymerizable silicone macromers which have at least one unsaturated group, e.g. linear or branched polydialkylsiloxanes which have a C₁-C₆-alkyl radical and a chain length of from 10 to 1000, preferably from 50 to 500, SiO(CₙH₂ₙ₊₁)₂ units. These can have one or two terminal or one or more internal polymerizable groups (functional groups). Examples are polydialkylsiloxanes having one or two vinyl, acryloxyalkyl, methacryloxyalkyl or mercaptoalkyl groups, with the alkyl groups being able to be identical or different and having from 1 to 6 carbon atoms. Preference is given to α,ω-divinylpolydimethylsiloxanes, α,ω-di(3-acryloxypropyl)polydimethylsiloxanes, α,ω-di(3-methacryloxypropyl)polydimethylsiloxanes, α-monovinylpolydimethylsiloxanes, α-mono(3-acryloxypropyl)polydimethylsiloxanes, α-mono(3-methacryloxypropyl)polydimethylsiloxanes, and also silicones having chain-transferring groups, e.g. α-mono(3-mercaptopropyl)polydimethylsiloxanes or α,ω-di(3-mercaptopropyl)polydimethylsiloxanes. The polymerizable silicone macromers described in EP-A 614924 are also suitable.

Further examples are precrosslinking comonomers such as multiply ethylenically unsaturated comonomers, for example divinyl adipate, divinylbenzene, diallyl maleate, allyl methacrylate, butanediol diacrylate or triallyl cyanurate, or postcrosslinking comonomers, for example acrylamidoglycolic acid (AGA), methyl methylacrylamidoglycolate (MAGME), N-methylolacrylamide (NMA), N-methylolmethacrylamide, allyl N-methylolcarbamate, alkyl ethers such as the isobutoxy ethers or esters of N-methylolacrylamide, of N-methylolmethacrylamide and of allyl N-methylolcarbamate.

The components a) are preferably selected so that aqueous copolymer dispersions and aqueous redispersions of the copolymer powders which have a minimum film formation temperature MFT of <10° C., preferably <5° C., in particular from 0° C. to 2° C., without addition of film formation aids are obtained. A person skilled in the art will know, on the basis of the glass transition temperature T_{g}, which monomers or monomer mixtures can be used for this purpose. The glass transition temperature T_{g} of the polymers can be determined in a known way by means of differential scanning calorimetry (DSC). The T_{g} can also be. calculated approximately beforehand by means of the Fox equation. According to Fox T. G., Bull. Am. Physics Soc. 1, 3, page 123 (1956): 1/T_{g}=×1/T_{g}1+×2/T_{g}2+ . . . +xn/T_{g}n, where xn is the mass fraction (% by weight/100) of the monomer n and T_{g}n is the glass transition temperature in Kelvin of the homopolymer of the monomer n. T_{g} values for homopolymers are given in the Polymer Handbook 2nd Edition, J. Wiley & Sons, New York (1975).

Preference is given to the copolymer compositions mentioned below:

polymers of vinyl acetate;

vinyl ester copolymers of vinyl acetate with further vinyl esters such as vinyl laurate, vinyl pivalate, vinyl 2-ethylhexanoate, vinyl esters of an alpha-branched carboxylic acid, in particular vinyl esters of Versatic acid (VeoVa9^{R}, VeoVa10^{R});

vinyl ester-ethylene copolymers such as vinyl acetateethylene copolymers which may further comprise additional vinyl esters such as vinyl laurate, vinyl pivalate, vinyl 2-ethylhexanoate, vinyl esters of an alpha-branched carboxylic acid, in particular vinyl esters of Versatic acid (VeoVa9^{R}, VeoVa10^{R}), or diesters of fumaric acid or maleic acid;

vinyl ester-ethylene copolymers such as vinyl acetateethylene copolymers which may further comprise additional vinyl esters such as vinyl laurate, vinyl pivalate, vinyl 2-ethylhexanoate, vinyl esters of an alpha-branched carboxylic acid, in particular vinyl esters of Versatic acid (VeoVa9^{R}, VeoVa10^{R}) and a polymerizable silicone macromer;

vinyl ester-ethylene-vinyl chloride copolymers in which vinyl acetate and/or vinyl propionate and/or one or more copolymerizable vinyl esters such as vinyl laurate, vinyl pivalate, vinyl 2-ethylhexanoate, vinyl esters of an alpha-branched carboxylic acid, in particular vinyl esters of Versatic acid (VeoVa9^{R}, VeoVa10^{R}), are preferably present as vinyl esters;

vinyl ester-acrylic ester copolymers with vinyl acetate and/or vinyl laurate and/or vinyl esters of Versatic acid and acrylic esters, in particular butyl acrylate or 2-ethylhexyl acrylate, which may further comprise ethylene;

acrylic ester copolymers, preferably those comprising n-butyl acrylate and/or 2-ethylhexyl acrylate;

methyl methacrylate copolymers, preferably those comprising butyl acrylate and/or 2-ethylhexyl acrylate, and/or 1,3-butadiene;

styrene-1,3-butadiene copolymers and styrene(meth)acrylic ester copolymers such as styrene-butyl acrylate, styrene-methyl methacrylate-butyl acrylate or styrene-2-ethylhexyl acrylate, with n-butyl, isobutyl, tert-butyl acrylate being able to be used as butyl acrylate.

The greatest preference is given to vinyl esterethylene copolymers such as vinyl acetate-ethylene copolymers and also copolymers of vinyl acetate and ethylene and vinyl esters of an α-branched carboxylic acid having 9 or 10 carbon atoms (VeoVa9^{R}, VeoVa10^{R}), and in particular copolymers of vinyl acetate, ethylene, vinyl esters of an α-branched carboxylic acid having 9 to 10 carbon atoms (VeoVa9^{R}, VeoVa10^{R}) with copolymerizable silicone macromers; having an ethylene content of preferably from 2 to 30% by weight, which may, if desired, further comprise additional auxiliary monomers in the amounts indicated.

The branched polysiloxanes b) comprise structural elements of the formula Y[—CₙH₂ₙ—(R₂SiO)ₘ-Ap-R₂Si-G]ₓ (I), where

Y is a trivalent to decavalent, preferably trivalent to tetravalent, hydrocarbon radical which may contain one or more heteroatoms selected from the group consisting of oxygen, nitrogen and silicon atoms, the radicals R can be identical or different and are each a monovalent, halogenated or unhalogenated hydrocarbon radical having from 1 to 18 carbon atoms per radical,

A is a radical of the formula —R₂Si—R¹—(R₂SiO)ₘ—, where R¹ is a divalent hydrocarbon radical which has from 2 to 30 carbon atoms and can be interrupted by one or more nonadjacent oxygen atoms, preferably from 1 to 4 nonadjacent oxygen atoms,

G is a monovalent radical of the formula —CₙH₂ₙ-Z or —CₙH₂ₙ₋₂ₖ-Z, or a divalent radical —CₙH₂ₙ—, where the second bond is to a further radical Y,

Z is a monovalent hydrophilic radical,

x is an integer from 3 to 10, preferably 3 or 4,

k is 0 or 1,

n is an integer from 1 to 12, preferably 2,

m is an integer of at least 1, preferably an integer from 1 to 1000, and

p is 0 or a positive integer, preferably 0 or an integer from 1 to 20,

with the proviso that the branched polysiloxanes have on average at least one group Z and the group Z contains at least one oxygen atom or nitrogen atom. The polysiloxanes having a branched structure comprise essentially chain-like siloxane blocks whose ends are each connected via a CₙH₂ₙ bridge to the structural elements Y and Z. The more siloxane blocks have elements Y bound to each end, the more branched are the products produced. In general, the polysiloxanes have a structure in which siloxane blocks and organic blocks alternate, with the branching structures and the ends consisting of organic blocks. Only stable Si—O—Si bonds or Si—C bonds are present in the molecule. The ratio of end groups Z to branching groups Y (Z/Y ratio) is preferably from 1.0 to 2.0, more preferably from 1.1 to 1.5. The polysiloxanes b) preferably have a viscosity of from 50 to 50,000,000 mPa·s at 25° C., more preferably from 500 to 5,000,000 mPa·s at 25° C. and particularly preferably from 100 to 1,000,000 mPa·s at 25° C.

Examples of radicals R are alkyl radicals such as the methyl, ethyl, n-propyl, isopropyl, n-butyl, isobutyl, tert-butyl, n-pentyl, isopentyl, neopentyl, tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical and octadecyl radicals such as the n-octadecyl radical; cycloalkyl radicals such as the cyclopentyl, cyclohexyl, cycloheptyl and methylcyclohexyl radicals; aryl radicals such as the phenyl, naphthyl, anthryl and phenanthryl radicals; alkaryl radicals such as the o-, m-, p-tolyl radicals, xylyl radicals and ethylphenyl radicals; and aralkyl radicals such as the benzyl radical, the α- and the β-phenylethyl radical.

Examples of halogenated radicals R are haloalkyl radicals such as the 3,3,3-trifluoro-n-propyl radical, the 2,2,2,2′,2′,2′-hexafluoroisopropyl radical, the heptafluoroisopropyl radical and haloaryl radicals such as the o-, m- and p-chlorophenyl radicals.

The radical R is preferably a monovalent hydrocarbon radical having from 1 to 6 carbon atoms, with the methyl radical being particularly preferred.

Examples of radicals R¹ are radicals of the formulae —(CH₂)₂—, —(CH₂)₄—, —(CH₂)₆—, —(CH₂)₈—, —(CH₂)₁₀—, —C₆H₄—, —C₂H₄C₆H₄C₂H₄—, —CH₂CH(CH₃)CH₆H₄CH(CH₃)CH₂— and —C₂H₄-norbornanediyl-.

Examples of the radical Y are radicals of the formulae 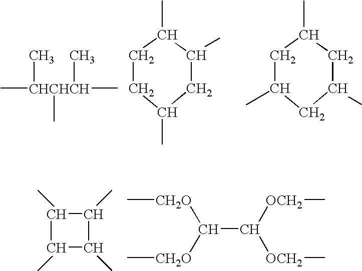
with the radical of the formula 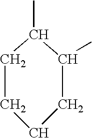
being particularly preferred.

Preferred radicals Z are derived from hydrophilic building blocks which can be present in monomeric, oligomeric or polymeric form and whose solubility in water under standard conditions (DIN 50014, 23/50) is ≧1 g/l. The molecular weight of the radicals Z is generally from 30 to 10 000.

Examples of polymeric radicals are polyols, polyethers such as polyalkylene oxides, preferably having methylene oxide, ethylene oxide (EO) or propylene oxide (PO) units or mixtures of these alkylene oxide units. Further examples are polyacids and salts thereof, preferably poly(meth)acrylic acid. Further suitable polymeric radicals are polyester, polyurea or polycarbonate radicals. Copolymers of (meth)acrylic ester monomers which further comprise comonomer units having functional groups such as carboxyl, amide, sulfonate, dialkylammonium and trialkylammonium groups are also suitable. Preferred (meth)acrylic ester monomers are those which have been mentioned above. As functional comonomers, preference is given to those mentioned under the auxiliary monomers a). The greatest preference is given to homocondensates and cocondensates of ethylene oxide and propylene oxide.

Examples of monomeric and oligomeric radicals Z are those having hydroxyl groups, carboxyl groups and salts thereof, sulfonic acid groups and salts thereof, sulfate groups, ammonium groups, keto groups, ether groups, ester groups, amide groups. Preference is given to radicals Z having an anionic or cationic charge, and also those having a zwitterionic structure. Further examples are:

—(CH₂)₁₋₆—O—CH₂—CHOH—CH₂—SO₃—Na⁺,

—(CH₂)₁₋₆—O—CH₂—CHOH—CH₂—N⁺(CH₃)₂CH₂CO₂⁻,

—(CH₂)₁₋₆-(EO)₁₀₋₂₀—O—CH₃,

—(CH₂)₁₋₆—O—SO₃—H₃N⁺—CH(CH₃)₂,

—(CH₂)₁₋₆—N⁺(CH₃)₂—(CH₂)₁₋₆—SO₃⁻,

—(CH₂)₁₋₆—O-(EO)₁₀₋₂₀—H,

—(CH₂)₁₋₆—CHOH—CH₂—N⁺(CH₃)₂CH₂CO₂⁻,

—(CH₂)₁₋₆—CHOH—CH₂—N⁺(CH₃)₂—CH(CH₃)CH₂—CO₂⁻.

Methods of preparing the branched polysiloxanes b) are known to those skilled in the art and are, for example, known from DE-A 10135305.

The silicone-containing polymers are prepared by means of free-radical polymerization in an aqueous medium, preferably emulsion polymerization. The polymerization is usually carried out in a temperature range from 20° C. to 100° C., in particular from 45° C. to 80° C. The polymerization is initiated by means of the customary free-radical initiators which are preferably used in amounts of from 0.01 to 3.0% by weight, based on the total weight of the monomers. As initiators, preference is given to using inorganic peroxides such as ammonium, sodium, potassium peroxodisulfate or hydrogen peroxide, either alone or in combination with reducing agents such as sodium sulfite, sodium hydrogensulfite, sodium formaldehydesulfoxylate or ascorbic acid. It is also possible to use water-soluble organic peroxides, for example t-butyl hydroperoxide, cumene hydroperoxide, usually in combination with reducing agents, or else water-soluble azo compounds. In the case of a copolymerization using gaseous monomers such as ethylene and vinyl chloride, the polymerization is carried out under superatmospheric pressure, generally in the range from 1 to 100 bar_{abs}.

To stabilize the dispersion, it is possible to use not only the polysiloxane component b) but also, in addition, anionic and nonionic emulsifiers and also protective colloids. Preference is given to using nonionic or anionic emulsifiers, preferably a mixture of nonionic and anionic emulsifiers. As nonionic emulsifiers, preference is given to condensation products of ethylene oxide or propylene oxide with linear or branched alcohols having from 8 to 18 carbon atoms, alkylphenols or linear or branched carboxylic acids having from 8 to 18 carbon atoms, and also block copolymers of ethylene oxide and propylene oxide. Suitable anionic emulsifiers are, for example, alkylsulfates, alkysulfonates, alkylarylsulfates and also sulfates or phosphates of condensation products of ethylene oxide with linear or branched alkyl alcohols having from 5 to 25 EO units, alkylphenols and monoesters or diesters of sulfosuccinic acid. The amount of emulsifier is from 0.01 to 40% by weight, based on the total weight of the monomers a) used.

If appropriate, protective colloids can also be used. Examples of suitable protective colloids are polyvinyl alcohols having a content of from 75 to 95 mol %, preferably from 84 to 92 mol %, of vinyl alcohol units; poly-N-vinylamides such as polyvinylpyrrolidones; polysaccharides such as starches, and also celluloses and their carboxymethyl, methyl, hydroxyethyl, hydroxypropyl derivatives; synthetic polymers such as poly(meth)acrylic acid, poly(meth)acrylamide. Particular preference is given to using the polyvinyl alcohols mentioned. The protective colloids are generally used in an amount of from 0.05 to 10% by weight, based on the total weight of the monomers a) used.

If appropriate, the molecular weight can be controlled by means of the customary regulators, for example alcohols such as isopropanol, aldehydes such as acetaldehyde, chlorine-containing compounds, mercaptans such as n-dodecyl mercaptan, t-dodecyl mercaptan, mercaptopropionic acid (esters). To set the pH, pH-regulating compounds such as sodium acetate or formic acid can be used in the preparation of the dispersion.

The polymerization can be carried out independently of the polymerization process with or without use of seed latices, with all or some constituents of the reaction mixture being initially charged, or with part being initially charged and the or some of the constituents of the reaction mixture subsequently being metered in, or by the feed stream process without an initial charge. The comonomers a) and, if appropriate, the auxiliary monomers can all be initially charged for the preparation of the dispersion (batch process), or part of the monomers is initially charged and the remainder is metered in (semibatch process).

To prepare the dispersion, the component b) can be initially charged or metered in, or part is initially charged and the remainder is metered in. The surface-active substances can be metered in alone or as a preemulsion with the comonomers.

In the copolymerization of gaseous monomers a) such as ethylene, the desired amount is introduced by setting of a particular pressure. The pressure under which the gaseous monomer is introduced can be set initially to a particular value and can decrease during the polymerization, or the pressure is kept constant during the entire polymerization. The latter embodiment is preferred.

After the polymerization is complete, an after-polymerization using known methods can be carried out to remove residual monomers, for example an after-polymerization initiated by means of redox catalysts. Volatile residual monomers and further volatile, nonaqueous constituents of the dispersion can also be removed by means of distillation, preferably under reduced pressure, and, if appropriate, with inert entrainer gases such as air, nitrogen or steam being passed through or over the reaction mixture.

The aqueous dispersions which can be obtained by the process of the invention have a solids content of from 30 to 70% by weight, preferably from 45 to 65% by weight. To prepare polymer powders, in particular water-redispersible polymer powders, the aqueous dispersions are dried, if appropriate after addition of protective colloids as atomization aids, for example by means of fluidized-bed drying, freeze drying or spray drying. The dispersions are preferably spray dried. Spray drying is carried out in customary spray-drying units, with atomization being able to be effected by means of single-fluid, two-fluid or multifluid nozzles or by means of a rotary disk. The added temperature is generally in the range from 45° C. to 120° C., preferably from 60° C. to 90° C., depending on the unit, the T_{g} of the resin and the desired degree of drying.

In general, the atomization aid is used in a total amount of from 3 to 30% by weight, based on the polymeric constituents of the dispersion. Suitable atomization aids are the abovementioned protective colloids. When carrying out the atomization, a content of up to 1.5% by weight of antifoam, based on the base polymer, has frequently been found to be advantageous. To improve the blocking stability, the powder obtained can be mixed with an antiblocking agent (anticaking agent), preferably in an amount of up to 30% by weight, based on the total weight of polymeric constituents. Examples of antiblocking agents are Ca carbonate or Mg carbonate, talc, gypsum, silica, kaolins, silicates.

Emulsion polymers which are hydrophobic, weathering-stable, water-repellent, very resistant and nonsoiling and additionally have a good water vapor permeability are obtained.

The silicone-containing polymers in the form of their aqueous dispersions and in the form of their polymer powders, in particular water-redispersible polymer powders, are suitable for use in adhesives and coating compositions, for the consolidation of fibers or other particulate materials, for example for the textile sector. They are also suitable as modifiers and as hydrophobicizing agents. They can also be used advantageously in polishes and in cosmetics, e.g. in the field of hair care. Furthermore, they are suitable as binders in adhesives and coating compositions, including as protective coating, e.g. for metals, films, wood, or as release coating, e.g. for paper treatment. They are particularly useful as binders for paints, adhesives and coating compositions in the building sector, for example in tile adhesives and thermal insulation adhesives, and in particular for use in low-emission plastic emulsion paints and plastic emulsion renders, both for interior use and for exterior use. The formulations for emulsion paints and emulsion renders are known to those skilled in the art and generally comprise from 5 to 50% by weight of the silicone-containing polymers, from 5 to 35% by weight of water, from 5 to 80% by weight of filler, from 5 to 30% by weight of pigments and from 0.1 to 10% by weight of further additives, with the percentages by weight in the formulation adding up to 100% by weight.

Examples of fillers which can be used are carbonates such as calcium carbonate in the form of dolomite, calcite and chalk. Further examples are silicates such as magnesium silicate in the form of talc or aluminum silicates such as clay and clay minerals; quartz flour, silica sand, finely divided silica, feldspar, barite and gypsum. Fibrous fillers are also suitable. In practice, use is frequently made of mixtures of different fillers. For example, mixtures of fillers having a different particle size or mixtures of carbonaceous and siliceous fillers. In the latter case, formulations having a proportion of more than 50% by weight, in particular more than 75% by weight, of carbonate or silicate in the total filler are referred to as carbonate-rich or silicate-rich formulations.

Plastic renders generally comprise coarser-grained fillers than emulsion paints. The particle size is in this case often in the range from 0.2 to 5.0 mm. Otherwise, plastic renders can comprise the same additives as emulsion paints.

Suitable pigments are, for example, titanium dioxide, zinc oxide, iron oxides, carbon black as inorganic pigments, and also the customary organic pigments. Examples of further additives are wetting agents in proportions of generally from 0.1 to 0.5% by weight, based on the total weight of the formulation. Examples are sodium and potassium polyphosphates, polyacrylic acids and salts thereof. Further additives which may be mentioned are thickeners which are generally used in an amount of from 0.01 to 2.0% by weight, based on the total weight of the formulation. Thickeners which can be used are cellulose ethers, starches or bentonite as an example of an inorganic thickener. Further additives are preservatives, antifoams, antifreezers.

To produce the adhesives and coating compositions, the polymer dispersion or the polymer powder is mixed with the further constituents of the formulation, viz. filler and further additives, in suitable mixers and homogenized. If desired, the polymer powder can also be added in the form of an aqueous redispersion on the building site. In many cases, a dry mix is prepared and the water necessary for processing is added immediately before processing. In the production of paste-like compositions, a frequently employed procedure is to initially charge the water, add the dispersion and finally stir in the solids.

The silicone-containing polymers are particularly advantageous as binders in coating formulations for low-emission interior paints, in particular those having a high PVK (highly filled paints), or as hydrophobicizing binder for renders.

The following examples serve to illustrate the invention without restricting it in any way.

Raw materials:

Genapol ×150:

Ethoxylated isotridecyl alcohol having a degree of ethoxylation of 15.

Genapol PF80:

EO-PO block polymer containing 80% of EO.

Mersolat:

Na alkylsulfonate having from 12 to 14 carbon atoms in the alkyl radical.

Polyvinyl alcohol W25/140:

Polyvinyl alcohol having a viscosity of about 25 mPas (20° C., 4% strength solution, measured by the Höppler method) and a saponification number of 140 (mg of KOH/g of polymer) (degree of hydrolysis: 88 mol %).

PDMS mixture:

Product of Wacker-Chemie GmbH: DEHESIVE 929, a linear polydimethylsiloxane having 78 mol % of vinyl end groups.

Preparative Examples for the Branched Polysiloxane—Component b)

In a glass flask provided with a mechanical stirrer, 108 g of 1,2,4-trivinylcyclohexane are mixed with 1840 g of an α,ω-dihydrogenpolymethylsiloxane having a content of active hydrogen (Si-bonded hydrogen) of 0.18% by weight and a viscosity of 9 mPas at 25° C. and 1.9 g of a solution of a platinum-1,3-divinyl-1,1,3,3-tetramethyldisiloxane complex in dimethylpolysiloxane (known as Karstedt catalyst) having a Pt content of 1.0% by weight are subsequently added. The reaction mixture heats up to about 80° C. in a few minutes and is stirred at this temperature for about 1 hour. A branched siloxane polymer having a viscosity of 220 mm²/s at 25° C. and a content of active hydrogen of 0.067% by weight is obtained. In accordance with the principle of the synthesis, all free siloxane chain ends consist of the highly reactive hydrogen dimethylsiloxy units.

The total amount of the highly branched SiH-functional siloxane polymer is mixed with 3200 g of a monoallyl-terminated polyether composed of equal molar amounts of ethyleneoxy and propyleneoxy groups and having an average molecular weight (Mₙ) of 1880 Da, activated by means of 5 g of a solution of hexachloroplatinic acid in isopropanol (0.5% Pt content) and heated to 100° C. After the mixture becomes clear, it is allowed to react further for 1 hour, after which a conversion of >98% is achieved. The highly branched polyether-siloxane copolymer has a viscosity of 6800 m²/s and a polyether content of about 62% by weight. It can be dispersed homogeneously in water without use of further auxiliaries.

### COMPARATIVE EXAMPLE 1

### Vinyl acetate-ethylene-vinylsilane copolymer without component b

102.99 kg of water, 17.90 kg of Genapol ×150 (40% strength aqueous solution), 3.54 kg of Mersolat (40% strength aqueous solution), 1.97 kg of sodium vinylsulfonate (25% strength), 13.95 kg of W 25/140 (polyvinyl alcohol, 10% strength in water) and 24.69 kg of vinyl acetate were placed in a 572 liter pressure autoclave. The mixture was brought to a pH of 5 by means of 10% strength formic acid. In addition, 314 ml of Trilon B (EDTA; 2% strength aqueous solution) and 991 ml of ammonium iron sulfate (1% strength solution) were added. The autoclave was heated to 70° C. and pressurized with 22 bar of ethylene. As soon as the reactor was in thermal equilibrium, a 10.0% strength ammonium peroxodisulfate solution (APS solution) was introduced at 1023 g per hour and a 5.05% strength sodium sulfite solution was introduced at 1976 g per hour. 25 minutes later, metered addition of a mixture of 217.25 kg of vinyl acetate and 1.25 kg of vinyltrimethoxysilane (Wacker Silan XL 10) at a rate of 41.23 kg per hour (metered addition of monomer) was commenced.

At the same time, an emulsifier mixture was introduced at a metering rate of 9.85 kg per hour. The emulsifier mixture comprised 22.34 kg of water, 12.96 kg of Genapol ×150 (40% strength aqueous solution) and 13.95 kg of W 25/140 (polyvinyl alcohol; 10% strength solution).

The total addition time for the metered addition of monomer was 5.3 hours and the total addition time for the metered addition of the emulsifier mixture was 5.0 hours.

15 minutes after the commencement of the reaction, the metered addition of APS was reduced to 636 g per hour, and the metered addition of Na sulfite was reduced to 1226 g per hour.

30 minutes after the end of the metered addition of emulsifier, the “GMA mixture” was introduced. Composition of the “GMA mixture”: 4.94 kg of vinyl acetate and 1.48 kg of glycidyl methacrylate. The metering time was

30 minutes (rate: 12.84 kg per hour). After the “GMA mixture” had all been added, the metered addition of APS and Na sulfite was continued for 1 hour. After depressurization, the dispersion was treated with steam (“stripped”) to minimize residual monomers and Hydorol W was subsequently added as preservative.

Dispersion analyses: see Table 1

### COMPARATIVE EXAMPLE 2

### Vinyl acetate-VeoVa-ethylene-vinylsilane-GMA-PDMS copolymer without component b

76.80 kg of water, 27.12 kg of W 25/140 (polyvinyl alcohol; 10% strength solution), 4.80 kg of Genapol ×150 (40% strength aqueous solution), 3.44 kg of Mersolat (40% strength aqueous solution), 1.92 kg of sodium vinylsulfonate (25% strength), 18.00 kg of vinyl acetate, 4.80 kg of PDMS mixture and 18.00 kg of VeoVa 10 were placed in a 572 liter pressure autoclave. The mixture was brought to a pH of 5 by means of 10% strength formic acid. In addition, 314 ml of Trilon B (EDTA; 2% strength aqueous solution) and 991 ml of ammonium iron sulfate (1% strength solution) were added. The autoclave was heated to 70° C. and pressurized with 13 bar of ethylene. As soon as the reactor was in thermal equilibrium, a 10.0% strength ammonium peroxodisulfate solution (APS solution) was introduced at 1023 g per hour and a 5.05% strength sodium sulfite solution was introduced at 1976 g per hour. 25 minutes later, metered addition of a mixture of 166.80 kg of vinyl acetate, 29.28 kg of VeoVa 10 and 1.22 kg of vinyltrimethoxysilane (Wacker Silan XL 10) at a rate of 34.02 kg per hour (metered addition of monomer) was commenced.

At the same time, an emulsifier mixture was introduced at a metering rate of 12.89 kg per hour. The emulsifier mixture comprised 45.69 kg of water and 25.20 kg of Genapol ×150 (40% strength aqueous solution). The total addition time for the metered addition of monomer was 5.8 hours and the total addition time for the metered addition of the emulsifier mixture was 5.5 hours.

15 minutes after the commencement of the reaction, the metered addition of APS was reduced to 636 g per hour, and the metered addition of Na sulfite was reduced to 1226 g per hour.

30 minutes after the end of the metered addition of emulsifier, the “GMA mixture” was introduced. Composition of the “GMA mixture”: 4.80 kg of vinyl acetate, 720.01 g of VeoVa 10 and 2.88 kg of glycidyl methacrylate. The metering time was 30 minutes (rate: 16.8 kg per hour). After the “GMA mixture” had all been added, the metered addition of APS and Na sulfite was continued for 1 hour. After depressuration, the dispersion was treated with steam (“stripped”) to minimize residual monomers and Hydorol W was subsequently added as preservative.

Dispersion analyses: see Table 1

### COMPARATIVE EXAMPLE 3

### Vinyl acetate-VeoVa-ethylene-vinylsilane-GMA-PDMS copolymer without component b

75.80 kg of water, 28.28 kg of W 25/140 (polyvinyl alcohol; 10% strength solution), 10.43 kg of Genapol PF 80 (19.2% strength aqueous solution), 3.58 kg of Mersolat (40% strength aqueous solution), 2.00 kg of sodium vinylsulfonate (25% strength), 230.24 g of sodium acetate (100% pure), 18.77 kg of vinyl acetate, 5.01 kg of PDMS mixture and 18.77 kg of VeoVa 10 were placed in a 572 liter pressure autoclave. The mixture was brought to a pH of 5 by means of 10% strength formic acid. In addition, 314 ml of Trilon B (EDTA; 2% strength aqueous solution) and 991 ml of ammonium iron sulfate (1% strength solution) were added. The autoclave was heated to 70° C. and pressurized with 13 bar of ethylene. As soon as the reactor was in thermal equilibrium, a 10.0% strength ammonium peroxodisulfate solution (APS solution) was introduced at 1023 g per hour and a 5.05% strength sodium sulfite solution was introduced at 1976 g per hour. 25 minutes later, metered addition of a mixture of 173.93 kg of vinyl acetate, 30.53 kg of VeoVa 10 and 1.28 kg of vinyltrimethoxysilane (Wacker Silan XL 10) at a rate of 35.48 kg per hour (metered addition of monomer) was commenced.

At the same time, an emulsifier mixture was introduced at a metering rate of 12.31 kg per hour. The emulsifier mixture comprised 12.18 kg of water and 54.74 kg of Genapol PF 80 (19.2% strength aqueous solution). The total addition time for the metered addition of monomer was 5.8 hours and the total addition time for the metered addition of the emulsifier mixture was 5.5 hours.

15 minutes after the commencement of the reaction, the metered addition of APS was reduced to 636 g per hour, and the metered addition of Na sulfite was reduced to 1226 g per hour.

30 minutes after the end of the metered addition of emulsifier, the “GMA mixture” was introduced. Composition of the “GMA mixture”: 5.01 kg of vinyl acetate, 750.78 g of VeoVa 10 and 3.00 kg of glycidyl methacrylate. The metering time was 30 minutes (rate: 17.52 kg per hour). After the “GMA mixture” had all been added, the metered addition of APS and Na sulfite was continued for 1 hour. After depressurization, the dispersion was treated with steam (“stripped”) to minimize residual monomers and Hydorol W was subsequently added as preservative.

Dispersion analyses: see Table 1

### EXAMPLE 4

### Copolymer Analogous to Comparative Ex. 2 with Component b

2.60 kg of water, 298.04 g of W 25/140 (polyvinyl alcohol; 10% strength solution), 212.88 kg of Genapol ×150 (40% strength aqueous solution), 157.9 g of Mersolat (30% strength aqueous solution), 68.12 g of sodium vinylsulfonate (25% strength), 851.53 g of vinyl acetate, 170.31 g of PDMS mixture and 851.53 g of VeoVa 10 were placed in a 19 liter pressure autoclave. The mixture was brought to a pH of 5 by means of 10% strength formic acid. In addition, 9.7 ml of Trilon B (EDTA; 2% strength aqueous solution) and 30.6 ml of ammonium iron sulfate (1% strength solution) were added. The autoclave was heated to 70° C. and pressurized with 14 bar of ethylene. As soon as the reactor was in thermal equilibrium, a 5.41% strength ammonium peroxodisulfate solution (APS solution) was introduced at 68 g per hour and a 4.16% strength sodium sulfite solution was introduced at 85 g per hour. 25 minutes later, metered addition of a mixture of 5.79 kg of vinyl acetate, 825.98 g of VeoVa 10 and 43.54 g of vinyltrimethoxysilane (Wacker Silan XL 10) at a rate of 1149 g per hour (metered addition of monomer) was commenced.

At the same time, an emulsifier mixture was introduced at a metering rate of 433 g per hour. The emulsifier mixture comprised 2.04 kg of water and 340.61 g of component b). The total addition time for the metered addition of monomer was 5.8 hours and the total addition time for the metered addition of the emulsifier mixture was 5.5 hours.

15 minutes after the commencement of the reaction, the metered addition of APS was reduced to 42.2 g per hour, and the metered addition of Na sulfite was reduced to 52.7 g per hour.

30 minutes after the end of the metered addition of emulsifier, the “GMA mixture” was introduced. Composition of the “IGMA mixture”: 170.31 g of vinyl acetate, 25.55 g of VeoVa 10 and 51.09 g of glycidyl methacrylate. The metering time was 30 minutes (rate: 494 g per hour). After the “GMA mixture” had all been added, the metered addition of APS and Na sulfite was continued for 1 hour. After depressurization, the dispersion was treated with steam (“stripped”) to minimize residual monomers and Hydorol W was subsequently added as preservative.

Dispersion analyses: see Table 1

### EXAMPLE 5

### Analogous to Example 4 without Mersolat

2.16 kg of water, 955.94 g of W 25/140 (polyvinyl alcohol; 10% strength solution), 84.60 g of component b), 156.87 g of Mersolat (30% strength aqueous solution), 67.68 g of sodium vinylsulfonate (25% strength), 845.96 g of vinyl acetate, 169.19 g of PDMS mixture and 845.96 g of VeoVa 10 were placed in a 19 liter pressure autoclave. The mixture was brought to a pH of 5 by means of 10% strength formic acid. In addition, 9.7 ml of Trilon B (EDTA; 2% strength aqueous solution) and 30.6 ml of ammonium iron sulfate (1% strength solution) were added. The autoclave was heated to 70° C. and pressurized with 14 bar of ethylene. As soon as the reactor was in thermal equilibrium, a 5.41% strength ammonium peroxodisulfate solution (APS solution) was introduced at 68 g per hour and a 4.16% strength sodium sulfite solution was introduced at 85 g per hour. 25 minutes later, metered addition of a mixture of 5.75 kg of vinyl acetate, 820.58 g of VeoVa 10 and 43.16 g of vinyltrimethoxysilane (Wacker Silan XL 10) at a rate of 1142 g per hour (metered addition of monomer) was commenced.

At the same time, an emulsifier mixture was introduced at a metering rate of 431 g per hour. The emulsifier mixture comprised 2.03 kg of water and 338.38 g of component b). The total addition time for the metered addition of monomer was 5.8 hours and the total addition time for the metered addition of the emulsifier mixture was 5.5 hours.

15 minutes after the commencement of the reaction, the metered addition of APS was reduced to 42.2 g per hour, and the metered addition of Na sulfite was reduced to 52.7 g per hour.

30 minutes after the end of the metered addition of emulsifier, the “GMA mixture” was introduced. Composition of the “IGMA mixture”: 169.19 g of vinyl acetate, 25.38 g of VeoVa 10 and 50.76 g of glycidyl methacrylate. The metering time was 30 minutes (rate: 491 g per hour). After the “GMA mixture” had all been added, the metered addition of APS and Na sulfite was continued for 1 hour. After depressurization, the dispersion was treated with steam (“stripped”) to minimize residual monomers and Hydorol W was subsequently added as preservative.

Dispersion analyses: see Table 1

### EXAMPLE 6

The procedure of Example 5 was repeated, but without addition of polyvinyl alcohol.

Dispersion analyses: see Table 1.

### EXAMPLE 7

### Analogous to Example 5 with Less Polyvinyl Alcohol

2.23 kg of water, 425.65 g of W 25/140 (polyvinyl alcohol; 10% strength solution), 567.54 g of component b) (15% strength aqueous solution), 157.86 g of Mersolat (30% strength aqueous solution), 68.10 g of sodium vinylsulfonate (25% strength), 851.31 g of vinyl acetate, 170.26 g of PDMS mixture and 851.31 g of VeoVa 10 were placed in a 19 liter pressure autoclave. The mixture was brought to a pH of 5 by means of 10% strength formic acid. In addition, 9.7 ml of Trilon B (EDTA; 2% strength aqueous solution) and 30.6 ml of ammonium iron sulfate (1% strength solution) were added. The autoclave was heated to 70° C. and pressurized with 14 bar of ethylene. As soon as the reactor was in thermal equilibrium, a 5.41% strength ammonium peroxodisulfate solution (APS solution) was introduced at 68 g per hour and a 4.16% strength sodium sulfite solution was introduced at 85 g per hour. 25 minutes later, metered addition of a mixture of 5.79 kg of vinyl acetate, 825.77 g of VeoVa 10 and 43.43 g of vinyltrimethoxysilane (Wacker Silan XL 10) at a rate of 1149 g per hour (metered addition of monomer) was commenced.

At the same time, an emulsifier mixture was introduced at a metering rate of 413 g per hour. The emulsifier mixture comprised 2.27 kg of component b) (15% strength aqueous solution). The total addition time for the metered addition of monomer was 5.8 hours and the total addition time for the metered addition of the emulsifier mixture was 5.5 hours.

15 minutes after the commencement of the reaction, the metered addition of APS was reduced to 42.2 g per hour, and the metered addition of Na sulfite was reduced to 52.7 g per hour.

30 minutes after the end of the metered addition of emulsifier, the “GMA mixture” was introduced. Composition of the “GMA mixture”: 170.26 g of vinyl acetate, 25.54 g of VeoVa 10 and 51.08 g of glycidyl methacrylate. The metering time was 30 minutes (rate: 494 g per hour). After the “GMA mixture” had all been added, the metered addition of APS and Na sulfite was continued for 1 hour. After depressurization, the dispersion was treated with steam (“stripped”) to minimize residual monomers and Hydorol W was subsequently added as preservative.

Dispersion analyses:

see Table 1

### EXAMPLE 8

### Copolymer without Silicone Macromer

2.04 kg of water, 221.50 g of Genapol ×150 (40% strength aqueous solution), 164.30 g of Mersolat (30% strength aqueous solution), 70.88 g of sodium vinylsulfonate (25% strength) and 886.0 g of vinyl acetate were placed in a 19 liter pressure autoclave. The mixture was brought to a pH of 5 by means of 10% strength formic acid. In addition, 9.7 ml of Trilon B (EDTA; 2% strength aqueous solution) and 30.6 ml of ammonium iron sulfate (1% strength solution) were added. The autoclave was heated to 70° C. and pressurized with 22 bar of ethylene. As soon as the reactor was in thermal equilibrium, a 5.41% strength ammonium peroxodisulfate solution (APS solution) was introduced at 68 g per hour and a 4.16% strength sodium sulfite solution was introduced at 85 g per hour. 25 minutes later, metered addition of a mixture of 6.91 kg of vinyl acetate and 45.20 g of vinyltrimethoxysilane (Wacker Silan XL 10) at a rate of 1200 g per hour (metered addition of monomer) was commenced.

At the same time, an emulsifier mixture was introduced at a metering rate of 611 g per hour. The emulsifier mixture comprised 1000.0 g of W 25/140 (polyvinyl alcohol; 10% strength solution) and 2.36 kg of component b) (15% strength aqueous solution). The total addition time for the metered addition of monomer was 5.8 hours and the total addition time for the metered addition of the emulsifier mixture was 5.5 hours.

15 minutes after the commencement of the reaction, the metered addition of APS was reduced to 42.2 g per hour, and the metered addition of Na sulfite was reduced to 52.7 g per hour.

30 minutes after the end of the metered addition of emulsifier, the “GMA mixture” was introduced. Composition of the “GMA mixture”: 177.20 g of vinyl acetate and 53.16 g of glycidyl methacrylate. The metering time was 30 minutes (rate: 462 g per hour). After the “GMA mixture” had all been added, the metered addition of APS and Na sulfite was continued for 1 hour.

After depressurization, the dispersion was treated with steam (“stripped”) to minimize residual monomers and Hydorol W was subsequently added as preservative.

Dispersion analyses: see Table 1

TABLE 1
Dispersion analyses

| | Tg | | BF 20 | D | Dn | Dv | SA | SC |
|---|---|---|---|---|---|---|---|---|
| Ex. | ° C. | pH | mPas | nm | μm | μm | M² | % |
| C1 | 10.3 | 5.15 | 8400 | 317 | 0.08 | 0.314 | 26.7 | 59.7 |
| C2 | 9.2 | 5.18 | 3220 | 390 | 0.08 | 0.759 | 16.7 | 58.0 |
| C3 | 14.7 | 5.20 | 11 600 | 410 | 0.12 | 0.650 | 14.7 | 58.7 |
| 4 | 11.3 | 4.97 | 780 | 430 | 0.14 | 0.802 | 9.5 | 59.3 |
| 5 | 12.2 | 5.00 | 5280 | 503 | 0.20 | 0.921 | 9.2 | 59.9 |
| 6 | 13.0 | 5.20 | 490 | 245 | 0.09 | 0.692 | 15.8 | 58.9 |
| 7 | 12.9 | 4.80 | 510 | 419 | 0.10 | 0.891 | 8.9 | 59.2 |
| 8 | 12.3 | 5.00 | 3000 | 305 | 0.08 | 0.492 | 20.3 | 55.9 |

BF 20 = Brookfield viscosity,
D = mean particle size (Nanosizer),
Dn = mean particle size (number average, Coulter Counter),
Dv = mean particle size (volume average, Coulter Counter),
SA = mean particle surface area per g of polymer dispersion
SC = solids content.

In Comparative Examples 1 to 3, emulsifiers and protective colloids known from the prior art were used for the emulsion polymerization. In Examples 4 to 8, branched polysiloxanes (component b) were used as emulsifiers.

As can be seen from Table 1, polymer dispersions having a proportion of silicone and an advantageous particle size distribution were obtained, and coagulum formation was not observed in a single case. The viscosity can be varied over a wide range via the amount of protective colloid (here polyvinyl alcohol W25/140) (Examples 5 and 7).

The dispersions were used to produce paints having a silicate-rich formulation 1 and a carbonate-rich formulation 2 in accordance with the formulations presented below (Tables 2 and 3):

TABLE 2
Paint formulation 1 (silicate-rich):

| | |
|---|---|
| Water | 350 |
| Cellulose ether (Tylose MH 10 000 KG4) | 5 |
| Dispersant (Dispex N 40) | 2 |
| Magnesium silicate (talc N) | 100 |
| Magnesium silicate (China clay grade B) | 100 |
| Titanium dioxide pigment (Kronos 2300) | 100 |
| Calcium carbonate (Omyacarb 5 GU) | 200 |
| Ammonia | 0.5 |
| Polymer dispersion (SC 60%) | 142.5 |
| Total parts by weight | 1000 |

TABLE 3
Paint formulation 2 (carbonate-rich):

| | |
|---|---|
| Water | 350 |
| Cellulose ether (Tylose MH 10 000 KG4) | 5 |
| Dispersant (Dispex N 40) | 2 |
| Titanium dioxide pigment (Kronos 2300) | 100 |
| Calcium carbonate (Omyacarb 5 GU) | 400 |
| Ammonia | 0.5 |
| Polymer dispersion (SC 60%) | 142.5 |
| Total parts by weight | 1000 |

The dispersions were also used to produce renders in accordance with the formulation presented below (Table 4):

TABLE 4
Render formulation 3

| | |
|---|---|
| Water | 91.2 |
| Dispersant (Dispex N 40) | 2 |
| Fungicide (Parmetol A23) | 2 |
| Sheet silicate thickener (Bentone EW, 5% strength) | 15 |
| Methylcellulose thickener (Tylose MH 10 000 KG4, | 30 |
| 2% strength) | |
| Acrylate thickener (Rohagit SD 15) | 1 |
| Algicide (Algon P) | 1 |
| Ammonia | 0.5 |
| Cellulose fibers (Arbocel B400) | 3 |
| Dralon fibers (Dralon fibers 6.7/4 mm) | 2 |
| Titanium dioxide (Kronos 2190) | 20 |
| Kieselguhr (Celite 281) | 40 |
| Chalk (Calcilit 100) | 360 |
| Chalk (Calcilit 1.5-2 mm) | 320 |
| Antifoam (Agitan 260) | 1 |
| Polymer dispersion (60% strength) | 111.3 |
| Total parts by weight | 1000 |

Use Tests:

Testing of the hydrophobicity by means of the water drop test

A render produced according to the above formulation 3 was applied by means of a spatula to 3 conventional, commercially available lime-sand bricks (dimensions: 10×10×5 cm) to particle size (about 2 mm, total of about 30-40 g of render per brick). After drying, 1 ml of water was placed in the form of a drop on the render by means of a syringe after 7 days. The time (in min) until the drop had spread and thus disappeared was recorded. The longer this time, the higher the hydrophobicity and the water resistance of the render or the dispersion present therein. In the case of a hydrophilic dispersion, the drop has disappeared after not more than 10 minutes, while it remains for a number of hours in the case of hydrophobic dispersions.

An analogous test was carried out using the paint formulations 1 and 2. However, these were applied in a layer thickness of about 400 μm to a commercial fibrocement sheet (Esterplan). Here too, the longer the drop remains, the more hydrophobic is the dispersion.

Table 5 shows the use data.

TABLE 5

| | Hydrophobicity | Hydrophobicity | Hydrophobicity |
|---|---|---|---|
| | Formulation 2 | Formulation 1 | Formulation 3 |
| | after 1 day in | after 1 day in | after 7 days |
| Example | min | min | in min |
| C1 | 120 | 110 | 5 |
| C2 | not measured | | |
| C3 | not measured | | |
| 4 | 410 | 400 | 160 |
| 5 | 390 | 370 | 175 |
| 6 | 410 | 420 | 180 |
| 7 | 430 | 460 | 200 |
| 8 | 360 | 350 | 100 |

The following can be seen from Table 5:

Comparison of Comparative Example 1 with Example 8 shows that the hydrophobicity can be increased significantly in all formulations when the silicone-containing polymer is used. As a comparison of Example 8 (copolymer without silicone macromer) with Examples 4, 5, 6 and 7 shows, the hydrophobicity can be improved further to an appreciable extent if a polymerizable silicone macromer is additionally copolymerized into the silicone-containing polymer.

1-22. (canceled)

23. A silicone-containing addition polymer, prepared by the process comprising free-radically polymerizing
a) from 60 to 99.99% by weight of at least one monomer selected from the group consisting of vinyl esters of unbranched or branched C₁₋₁₅ alkylcarboxylic acids, methacrylic esters and acrylic esters of C₁₋₁₅ alcohols, vinylaromatics, monoolefins, dienes, and vinyl halides,
in the presence of
b) from 0.01 to 40% by weight of at least one branched polysiloxane having lipophilic and hydrophilic portions, at least one lipophilic siloxane portion comprising a branched siloxane structure, and at least one hydrophilic organopolymer portion which is linear or branched,
where the percentages by weight are based on the total weight of a) and b).

24. The silicone-containing polymer of claim 23, wherein a branched polysiloxane b) comprises structural elements of the formula Y[—CₙH₂ₙ—(_{R2SiO})ₘ-Aₚ-R₂Si-G]ₓ (I), where
Y is a trivalent to decavalent hydrocarbon radical optionally containing one or more heteroatoms selected from the group consisting of oxygen, nitrogen and silicon atoms, radicals R are identical or different monovalent, optionally halogenated C₁₋₁₈ hydrocarbon radicals,
A is a radical of the formula —R₂Si—R¹—(R₂SiO)ₘ—, where R¹ is a divalent C₂₋₃₀ hydrocarbon radical, the carbon atoms of which are optionally interrupted by one or more nonadjacent oxygen atoms,
G is a monovalent radical of the formula —CₙH₂ₙ-Z or —CₙH₂ₙ₋₂ₖ-Z, or a divalent radical—CₙH₂ₙ— where the second bond in the divalent radical is to a further radical Y,
Z is a monovalent hydrophilic radical,
x is an integer from 3 to 10,
k is 0 or 1,
n is an integer from 1 to 12,
m is an integer of at least 1, and
p is 0 or a positive integer, with the proviso that the branched polysiloxanes have on average at least one group Z and the group Z contains at least one oxygen atom or nitrogen atom.

25. The silicone-containing polymer of claim 24, wherein
Y is a trivalent or tetravalent radical;
A is a radical wherein R¹ contains from 1 to 4 nonadjacent oxygen atoms;
x is 3 or 4;
n is 2;
m is an integer from 1 to 1000; and
p is 0 or an integer from 1 to 20.

26. The silicone-containing polymer as claimed in claim 23, characterized in that at least one radical Y is selected from radicals of the group consisting of

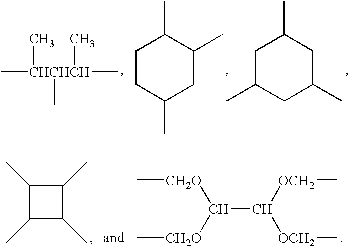

27. The silicone-containing polymer of claim 23, wherein the radical Z comprises a hydrophilic building block in monomeric, oligomeric or polymeric form, and whose solubility in water under standard conditions is ≧1 g/l.

28. The silicone-containing polymer of claim 27, wherein at least one radical Z is a hydrophilic polymer selected from the group consisting of polyols, polyethers, polyacids and salts thereof, polyesters, polyureas, polycarbonates, and copolymers prepared from (meth)acrylic ester monomers and further copolymerizable comonomers bearing at least one carboxyl, amide, sulfonate, dialkylammonium, or trialkylammonium functional group.

29. The silicone-containing polymer of claim 28, wherein at least one radical Z comprises a homocondensate or cocondensate containing at least one alkylene oxide selected from the group consisting of ethylene oxide and propylene oxide.

30. The silicone-containing polymer of claim 27, wherein at least one radical Z contains a monomeric or polymeric radical bearing a hydrophilic radical selected from the group consisting of hydroxyl groups, carboxyl groups and salts thereof, sulfonic acid groups and salts thereof, sulfate groups, ammonium groups, keto groups, ether groups, ester groups, and amide groups.

31. The silicone-containing polymer of claim 27, wherein at least one radical Z contains a radical selected from the group consisting of
—(CH₂)₁₋₆—O—CH₂—CHOH—CH₂—SO₃—Na⁺,
—(CH₂)₁₋₆—O—CH₂—CHOH—CH₂—N⁺(CH₃)₂CH₂CO₂⁻,
—(CH₂)₁₋₆-(EO)₁₀₋₂₀—O—CH₃,
—(CH₂)₁₋₆—O—SO₃—H₃N⁺—CH(CH₃)₂,
—(CH₂)₁₋₆—N⁺(CH₃)₂—(CH₂)₁₋₆—SO₃—,
—(CH₂)₁₋₆—O-(EO)₁₀₋₂₀—H,
—(CH₂)₁₋₆—CHOH—CH₂—N⁺(CH₃)₂CH₂CO₂⁻, and
—(CH₂)₁₋₆—CHOH—CH₂—N⁺(CH₃)₂—CH(CH₃)CH₂—CO₂⁻.

32. The silicone-containing polymer of claim 23, wherein one or more silanes selected from the group consisting of γ-acryloxypropyltri(alkoxy)silanes, and γ-methacryloxypropyltri(alkoxy)silanes, ω-methacryloxymethyltri(alkoxy)silanes, γ-methacryloxypropylmethyldi(alkoxy)silanes, vinylalkyldi(alkoxy)silanes and vinyltri(alkoxy)silanes are additionally copolymerized with the monomers a).

33. The silicone-containing polymer of claim 23, wherein one or more epoxy-functional monomers selected from the group consisting of glycidyl acrylate, glycidyl methacrylate, allyl glycidyl ether and vinyl glycidyl ether are additionally copolymerized with the monomers a).

34. The silicone-containing polymer of claim 23, wherein one or more silicone macromers bearing at least one unsaturated group, and selected from the group consisting of linear or branched polydi(C₁₋₆ alkyl)-siloxanes with a chain length of from 10 to 1000 SiO(CₙH₂ₙ₊₁)₂ units and which contain one or two terminal and/or internal polymerizable groups are additionally copolymerized with the monomers a).

35. A process for preparing a silicone-containing polymer of claim 23, comprising emulsion polymerizing polymerizable monomers comprising
a) from 60 to 99.99% by weight of at least one monomer selected from the group consisting of vinyl esters of unbranched or branched C₁₋₁₅ alkylcarboxylic acids, methacrylic esters and acrylic esters of C₁₋₁₅ alcohols, vinylaromatics, monoolefins, dienes, and vinyl halides,
in the presence of
b) from 0.01 to 40% by weight of at least one branched polysiloxane having lipophilic and hydrophilic portions, at least one lipophilic siloxane portion comprising a branched siloxane structure, and at least one hydrophilic organopolymer portion which is linear or branched,
where the percentages by weight are based on the total weight of a) and b), and optionally drying a resulting polymer dispersion to a polymer powder.

36. In a paint or coating composition wherein a silicone-containing polymer is employed, the improvement comprising selecting as at least one silicone-containing polymer, a silicone-containing polymer of claim 23.

37. In a paint or coating composition wherein a silicone-containing polymer is employed, the improvement comprising selecting as at least one silicone-containing polymer, a silicone-containing polymer of claim 24.

38. The composition of claim 36 which is an adhesive, silicate-rich paint, carbonate-rich paint, protective coating, release coating, or render.

39. A cosmetic formulation comprising at last one silicone-containing polymer of claim 23, and at least one further cosmetically acceptable ingredient.

40. The cosmetic formulation of claim 39 which is a hair care formulation.
